(19) United States
(12) Patent Application Publication
(10) Pub. No.: US 2026/0276084 A1
(43) Pub. Date: Sep. 17, 2026

(54) FLEXIBLE CUP BUNG FOR SELF-ALIGNED SEALING WITHIN A DRAFTED CHANNEL

(71) Applicant: Coagulo Medical Technologies, Inc., Auburndale, MA (US)

(72) Inventors: Galit H. Frydman, Boston, MA (US); Alexander H. Slocum, Bow, NH (US); Jake Sullivan, Pembroke, MA (US)

(21) Appl. No.: 19/470,775

(22) PCT Filed: Mar. 26, 2024
(86) PCT No.: PCT/US2024/021441

§ 371 Date: Sep. 29, 2025

Related U.S. Application Data
(60) Provisional application No. 63/455,915, filed on Mar. 30, 2023.

(51) Int. Cl. F16J 15/3204

(52) U.S. Cl. CPC F16J 15/3204

(57) ABSTRACT

Described herein are embodiments of a bung comprising a flexible cup cavity on its sealing side among other features, wherein the bung can maintain a seal with the walls of a channel that has a non-uniform diameter across its length. A bung as described herein can be used with an independent force actuator to generate kinetic energy in either a liquid or a gas, inside a closed system such as a self-contained, single-use medical device, for example.

### FIELD OF THE INVENTION

The present invention relates to a bung that exhibits continuous seal performance as the bung travels through a channel of non-uniform diameter. Disclosed herein are certain design specifications for a bung that maintains a self-aligning, pressurized bung seal across a range of compressions and misalignment scenarios inherent in piston seal assemblies comprising a channel of non-uniform diameter (e.g., a drafted channel that has been molded and that consequently has a taper along its length), and/or involving a bung that is acted upon by an independent external force actuator (e.g., piston, stinger rod, screw, etc.) to move the bung through a channel.

### BACKGROUND OF THE INVENTION

Traditionally, mechanical piston systems have been used to transfer the force of a pressurized gas or liquid over a cross-sectional area, thereby generating mechanical work that displaces an object and changes its kinetic energy. Common examples of such a transfer of energy include displacement of liquid through a syringe and the combustion of gasses in a combustion engine's piston to turn a drive shaft. Sealing of the gas or liquid is required to properly pressurize such systems and allow for the transfer of force into and out of the system. In such systems, a uniform diameter across the length of the piston chamber has traditionally been used to ensure a continuous seal throughout the displacement process.

It is common to incorporate angled walls into the design of injection molded plastic parts and cast metal parts, such as metal parts fashioned from aluminum. The feature of angled walls is commonly referred to as “wall draft” in the mechanical field. These drafted walls impart certain benefits, such as relieving stresses during the manufacturing of parts, and facilitating removal of a molded or cast part from a manufacturing or tooling mold by decreasing frictional surface area and shear stress during separation. However, when such drafted walls are used to form the walls of a channel, they also present a unique challenge to sealing and/or maintaining pressurization of a bung seal within the channel, as the bung must maintain the seal along some length of the channel despite the channel's non-uniform diameter (in other words, the point of contact between the bung and the channel wall is not constant). Maintaining a bung seal within a channel of non-uniform diameter is particularly challenging but is also particularly important when the intended use of such a channel is to transfer energy through pressurized piston displacement, e.g., to move a fluid sample through a closed system, as in a fully contained, single-use cartridge in a medical diagnostic device.

Because single-use disposables commonly comprise one or more injection molded or cast parts, there is a need in the art for a bung that is capable of spanning the width of a channel and forming a seal, notwithstanding that the channel may have a draft or a variable draft and thus a non-uniform diameter. The present invention meets this need. Described herein are embodiments of a bung comprising alignment features that ensure contact point alignment between the bung, the non-uniform channel wall, and a force actuator, such as a piston rod, particularly when such actuator is not physically linked to either the bung or the channel. These alignment features, as described herein, allow for containment and force transfer within a system such as a disposable cartridge that comprises a bung and a force actuator, physically unlinked to the bung, that pushes the bung (and thereby the bung seal) through a drafted channel.

### SUMMARY OF THE INVENTION

Described herein are features of a sealed system in which an independent, physically unlinked external force actuator pushes a self-aligning, unattached bung within a channel of non-uniform diameter. As used herein, unless described otherwise, a “drafted channel” refers to any channel having a non-uniform diameter along at least some part of its length. In any of the devices, systems, and methods described herein, a drafted channel may be made, for example, through the mechanical manufacturing processes of CNC (computer numerical control) machining, extrusion, injection molding, or die casting of materials.

The alignment features described herein allow a bung to maintain a seal with a channel wall while traveling through a channel that has a non-uniform channel diameter and provide for alignment of the bung to both the drafted channel as well as to an independent force actuator that is not permanently attached to other elements of the system (such as the bung, the channel, etc.).

Embodiments of the invention provide a bung with a cup-shaped sealing side and, opposite the cup-shaped sealing side, a tail end that interfaces with an independent, physically unlinked external force actuator. In certain embodiments, such as where the bung must maintain a pressurized seal with a drafted channel, certain of the bung's dimensions are directly related to one another and/or to the minimum channel diameter, the maximum channel diameter, and/or the channel draft angle. Unless described otherwise, channel diameter as used herein refers to the internal channel diameter.

In various embodiments, a bung as described herein comprises a cup-shaped cavity on its sealing side, wherein the particular dimensions of the cup-shaped cavity help ensure that the bung creates a seal with the channel walls and maintains that seal while traveling within the channel, notwithstanding that the channel may have a non-uniform diameter. The cup-shaped cavity may also be called a concave cavity or a relief cavity, or simply a cup cavity. Unlike bungs commonly used in constant diameter systems, a bung in embodiments of the present invention is missing certain bung material on its sealing side, where the cup-shaped cavity is located; the cup-shaped cavity comprises a bung sealing wall surrounding a collapsible relief area that allows for compliance during travel and a reliable variable diameter seal. The exact shape of the cup-shaped cavity depends on the application of the bung and can vary, as described herein.

In some embodiments, the dimensions of the bung's cup-shaped cavity on its sealing side dictate certain other of the bung's dimensions (e.g., total bung length, thickness, etc.) and/or features (e.g., shape). In further embodiments, certain of these other dimensions and features may also relate to the channel's minimum and maximum diameters.

In certain embodiments of a bung as described herein, the external force actuator side, referred to as the tail end of the bung, comprises design features that influence the dimensions and shape of the bung. Such features include the dimensions of the tail-end interface cavity (also called stinger cavity, actuating rod cavity, docking cavity, piston cavity, or simply tail-end cavity) that supports and facilitates contact with and alignment to a physically unlinked force actuator. In addition, as discussed herein, the length of bung tail end (see 807 in FIG. 1D) determines the maximum allowable angular offset of the bung in the channel (see FIG. 6A).

Accordingly, embodiments of the present invention provide a bung comprising a concave cavity (800a) on the bung's sealing end, wherein the concave cavity provides a physical relief that allows for deformation of the bung's sealing end (the forward lip region 800c) and a positive interference seal at the sealing contact point, as the bung travels through a channel of variable diameter (e.g., a channel with drafted walls). When such a bung travels through a channel, pressure and thus force is directed over the surface area of the bung's concave cavity, perpendicular to the channel walls, thereby increasing the sealing pressure of the bung. For a bung that is not physically attached to an actuator (e.g., piston pump rod) or other containing force, the bung's concave cavity on the positive pressure side of the channel allows the bung to maintain a pressurized seal with the channel wall.

In addition, as described herein, embodiments of the bung further comprise a tail-end cavity (800b) with tailing walls (800d). The shape of the tail-end cavity can be designed to reduce and control angular misalignment of the bung during travel (the tail end helps to steer the bung forward so the bung does not tilt and become jammed), and thus the properties of the tail-end cavity (along with total bung length and bug sealing cup diameter) can also promote sealing. In certain embodiments, the total bung length (80b in FIG. 1D) is greater than about twice the cup sealing diameter 802 of the bung, and in further embodiments the total bung length is greater than three times the bung's diameter; having the total bung length be greater than two times, or greater than three times, the bung's diameter helps in maintaining a stable forward alignment and thus improves the sealing ability of the bung.

In some embodiments, at least five dimensions of a bung ensure that the bung maintains a seal with the walls of a drafted channel. In certain embodiments, these dimensions include the thickness of the cup-shaped cavity wall (801), the cup sealing diameter (802), the length of the sealing end (804), the cup-shaped cavity wall resistive diameter (the diameter measured using the cup's exterior wall edge at the open end of the cup) (805), the thickness of the bung above its cup-shaped cavity (also known as the distance between the cup-shaped cavity and the stinger cavity located at the tail-end of the bung) (803), the length of the tail cavity (807) that receives the pushing member (e.g., a stinger rod), the diameter of the tail cavity (808), and the tail cavity's nominal wall thickness (809). These dimensions, in the proportions shown in the embodiment depicted in FIG. 1D, have been found to work well. For example, a bung with these dimensions in the proportions as shown in the embodiment in FIG. 1D is able to travel in a drafted channel while maintaining a seal with the channel walls, sealing against pressure from a fluid located ahead of the bung, and while being pushed at its rear by a stinger rod; the bung maintains a seal without being tilted sideways and without leaking, and once the stinger is withdrawn, the bung remains fixed in place in the channel even in the presence of back pressure from the fluid of up to 1 atm.

In certain embodiments, the location of contact between the actuator (e.g., piston pump rod) and the bung, and the center of friction of the bung (the force of friction of the bung being located along the bung cup sealing diameter's plane, at the points of contact between the bung and channel wall), have a defined distance from each other. As this distance decreases, so too does bung rotation (tilt) created by the force of friction of the channel wall acting on the bung, when force is being applied through the actuator. In certain embodiments, the location of contact between the actuator and the bung is closer to the sealing end of the bung than to the tail end of the bung. In addition, in certain embodiments the ratio of total bung length 80b, to the distance between the tail 800e of the bung to the actuator-bung contact 855 (i.e., 80b/807) is about equal to or greater than 1.6.

In some embodiments, a bung of the present invention comprises the following features:
a concave cavity at the sealing end of the bung; such concave cavity can deform and accommodate a draft angle of a channel, as the bung travels through a drafted channel, and thereby assists in maintaining sealing pressure;
a docking cavity at the tail end of the bung; such docking cavity aligns the bung and actuator (e.g., a piston pump rod) to the drafted channel; in addition, the distance between the docking cavity and the concave cavity can be set to reduce distance between the center of friction of the bung and the location of the actuator's application of force (such distance affects bung rotation, as described herein); and
tailing walls at the tail end of the bung; such tailing walls may have a defined length from the bung seal and may serve to align the bung angularly and resist frictional moments.
   The aforementioned features contribute to the effective movement of an independent bung through a channel having a non-uniform diameter (e.g., a drafted channel). A bung comprising these features can be physically unconnected to the actuator and yet still maintain a continuous seal with the channel wall, in a channel having a non-uniform diameter across its length.

### BRIEF DESCRIPTION OF THE DRAWINGS

FIG. 1A shows an isometric view of an embodiment of a bung.

FIG. 1B shows a cross-sectional view of an embodiment of a bung.

FIG. 1C shows certain key design features of an embodiment of a bung.

FIG. 1D shows certain key dimensions of an embodiment of a bung.

FIG. 2A shows a view looking into the sealing end of an embodiment of a bung.

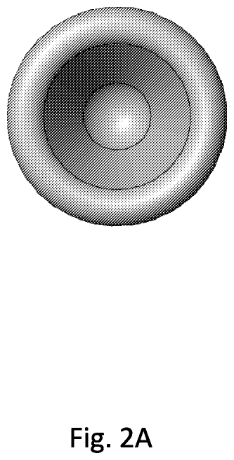

FIG. 2B shows a view looking into the tail end of an embodiment of a bung.

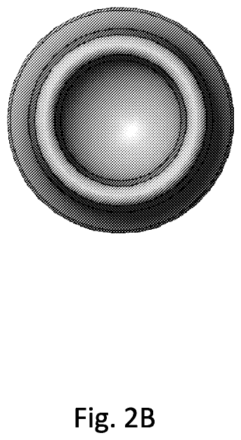

FIG. 3A shows a view of a bung embodiment with an actuating rod (stinger) inserted into the bung.

FIG. 3B shows a cross-sectional view of a bung embodiment and an actuating rod.

FIG. 4 shows a cross-sectional view of a bung embodiment and an actuating rod, as the bung is fit into a drafted channel.

FIG. 5A shows a cross-sectional view illustrating bung interference at the smallest diameter in a drafted channel.

FIG. 5B shows a cross-sectional view illustrating bung interference at the smallest diameter (most narrow region) in a drafted channel.

FIG. 5C shows a cross-sectional view illustrating percent squeeze of the cup sealing diameter of a bung embodiment, when the bung is located at a narrow region of the drafted channel.

FIG. 6A shows a cross-sectional view illustrating maximum allowable angular offset of a bung in a channel.

FIG. 6B shows a cross-sectional close-up view of a bung embodiment's sealing side, illustrating the points of contact between the bung's cup wall and a channel wall, at maximum allowable angular offset.

FIG. 6C shows a cross-sectional view of a bung embodiment, illustrating points of contact between the bung's tail end and a channel wall, at maximum allowable angular offset.

FIG. 6D shows a cross-sectional view of a bung embodiment, illustrating points of contact between the bung tail end and an external actuator, at maximum allowable angular offset.

FIG. 6E shows a cross-sectional view of a bung embodiment, illustrating a bung being engaged by an external actuator, without any tilt of the bung in a channel.

### DETAILED DESCRIPTION OF THE INVENTION

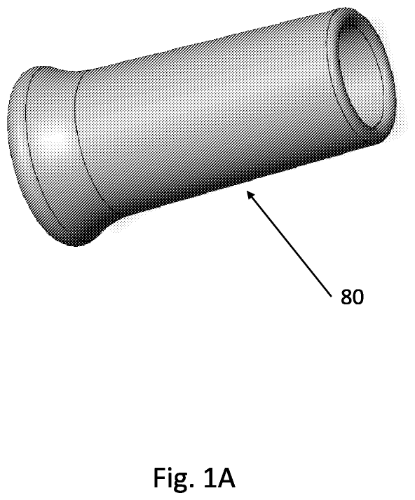

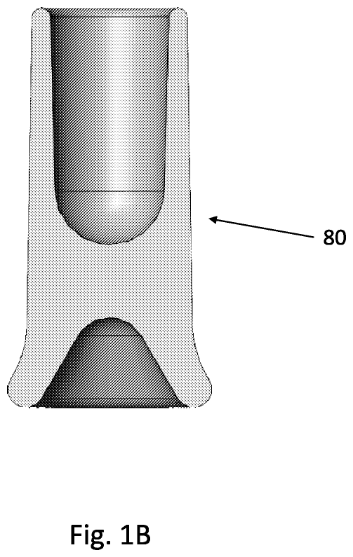

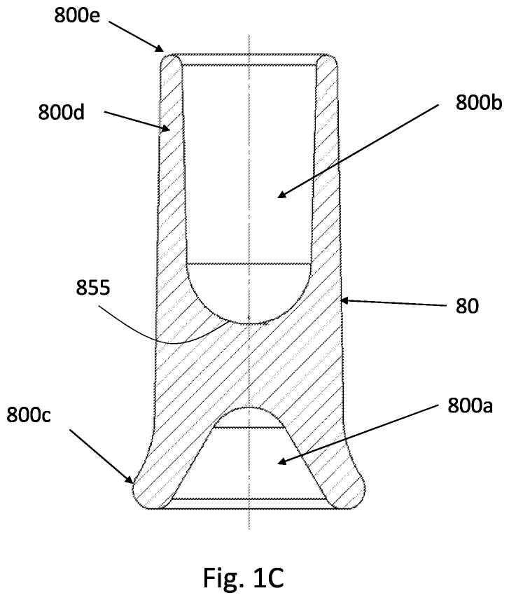

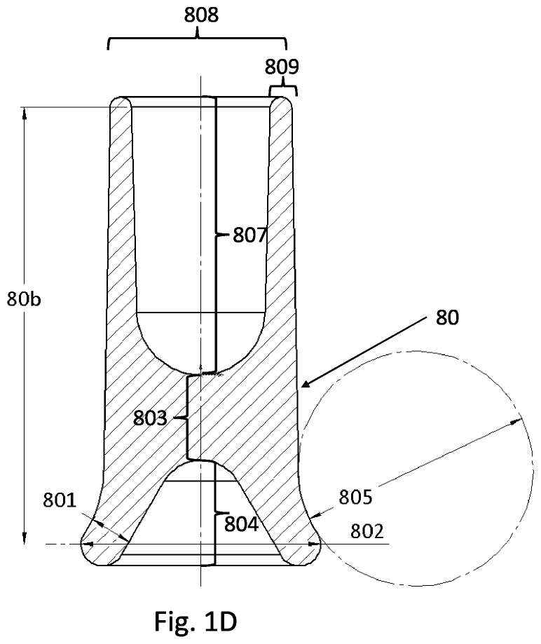

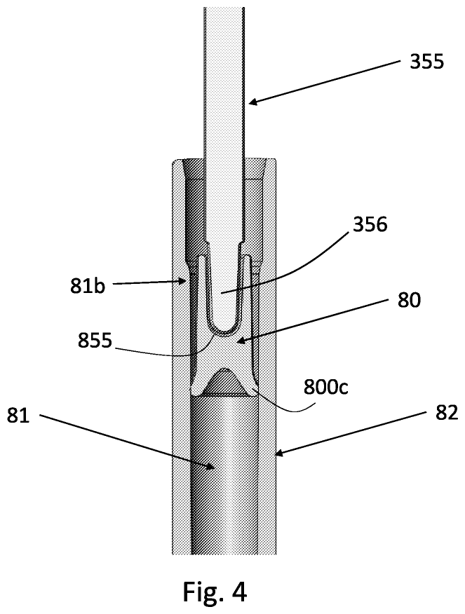

Described herein are embodiments of a sealed bung-piston rod system, wherein an independent bung is pushed through a channel of non-uniform diameter (e.g., a drafted channel). For example, FIG. 1C shows a cross-sectional view of an illustrative embodiment, wherein an initial contact preload is established at the bung sealing lip 800c, as the sealing lip contacts the channel wall upon insertion of bung 80 into a drafted channel such as 81 in cylindrical structure 82, as shown in FIG. 4. In certain embodiments, the depth of the bung's insertion into the channel, and/or the percent of contact between the bung and the drafted channel's surface area at 800c, can be set or otherwise selected using an assembly fixture. For example, an assembly fixture may be used to ensure insertion of the bung into the drafted channel to a preset depth. In certain embodiments, an assembly fixture may comprise a centering pin, wherein the pin is centered with respect to the drafted channel and is situated concentrically in line with a force actuator, such as a force transferring piston rod. Once a bung as described herein is inserted into the channel, bung contact and concentricity with the channel can be reliably maintained throughout the forced displacement of the bung along some length of the drafted channel.

In various embodiments (see, e.g., FIG. 1C), a cup-shaped cavity in the bung, at its sealing side (see 800a in FIG. 1C), is important for creating and maintaining a constant seal between the bung and the drafted walls of a channel. In further embodiments, a cup-shaped cavity 800a may take the shape of, for example, a v-shaped cone or trapezoidal cavity, or a rounded u-shaped cavity. Such a cavity on the seal-side of the bung provides a physical, collapsible relief that allows for the tangential contact point of the bung to the channel wall (at 800c) to adjust to changing channel diameter. The cavity further provides a surface region in which pressure can seal the bung to the non-uniform channel walls.

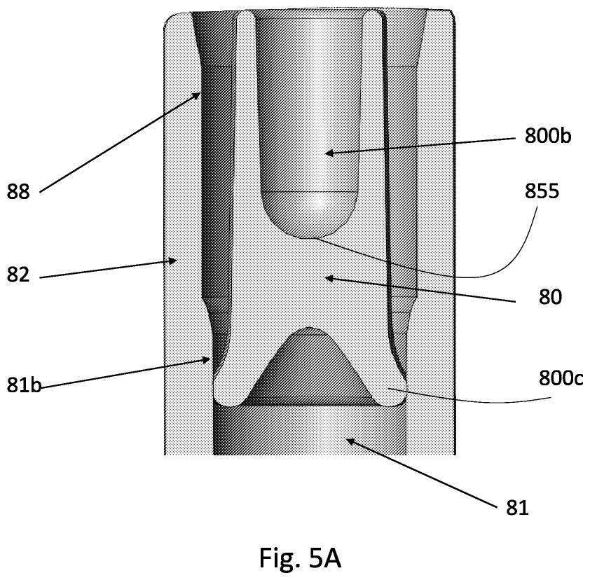

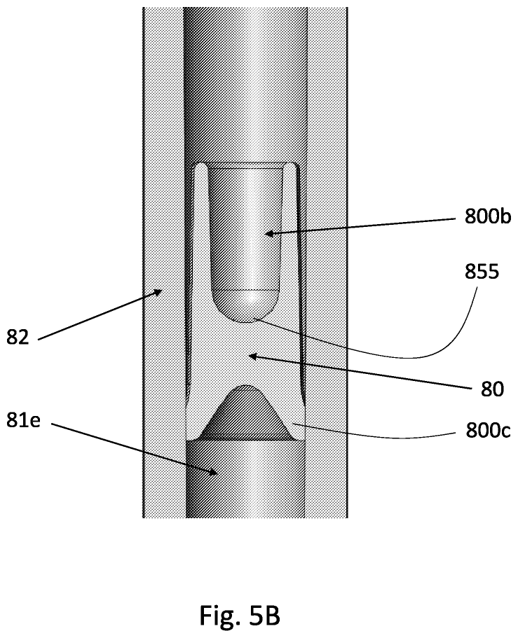

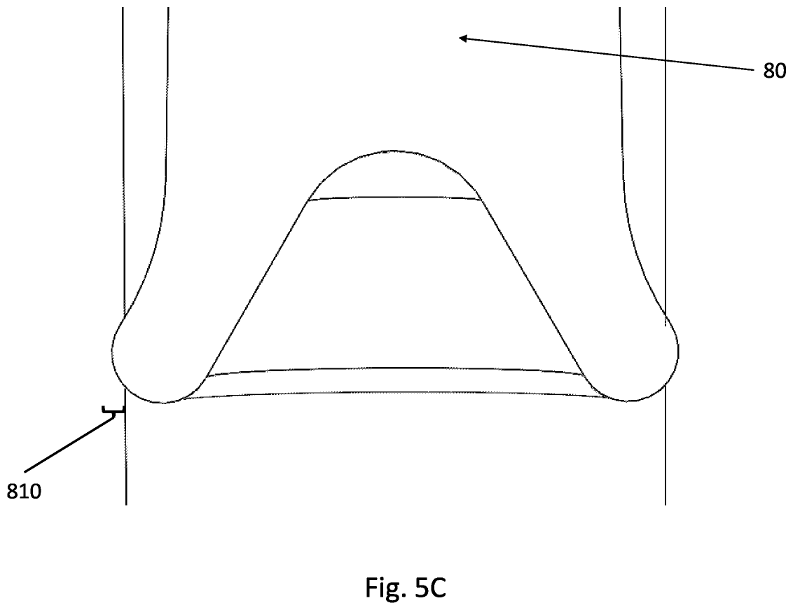

In certain embodiments, particular dimensions and properties of the bung are critical to ensuring that the bung maintains a seal with the walls of a channel of non-uniform diameter. These dimensions include the cup sealing diameter 802, the bung tail-end diameter 808, the total bung length 80b (which is the length in between the cup sealing diameter and the tail-end diameter 808, as shown in the embodiment in FIG. 1D), and the minimum and maximum percent squeeze of the cup sealing diameter (see, e.g., FIG. 5C) where the percent squeeze is 100× (as-manufactured cup sealing diameter 802 minus the channel diameter)/the as-manufactured cup sealing diameter 802.

Reasonable values for the minimum and maximum percent squeeze (also known as “crush”) include values from 3% to 25%. The minimum percent squeeze may be the percent squeeze that occurs when the bung is at the beginning of its stroke in a drafted channel, and the maximum percent squeeze may be the percent squeeze that occurs when the bung is at the end of its stroke in a drafted channel. In the embodiment depicted in FIG. 5A, the bung 80 has entered the entrance region 88 of the drafted channel 81 in the cylindrical structure 82, and the bung's sealing lip 800c is in the beginning portion 81b of the drafted channel 81. This posture would be the condition that occurs in a manufactured cartridge comprising a drafted channel, when a bung as described herein has been inserted into the drafted channel, sealing the drafted channel, and the bung is then ready to be engaged by a stinger and be pushed forward to activate the cartridge process. FIG. 5B shows bung 80 in its forwardmost position in the drafted channel, which has an end region 81e; the end region 81e has a diameter that is smaller than the diameter of the beginning portion 81b because of molding draft requirements (for example, the draft (taper) of a molded part is typically 3 degrees). At this location in the drafted channel, the bung sealing lip is more compressed than it was when the bung was at the entrance region. This greater compression is made possible by the bung's design and ensures that once the stinger is removed, the bung does not slip out of the channel and the liquids or gasses in the cartridge thus will still be contained in the cartridge.

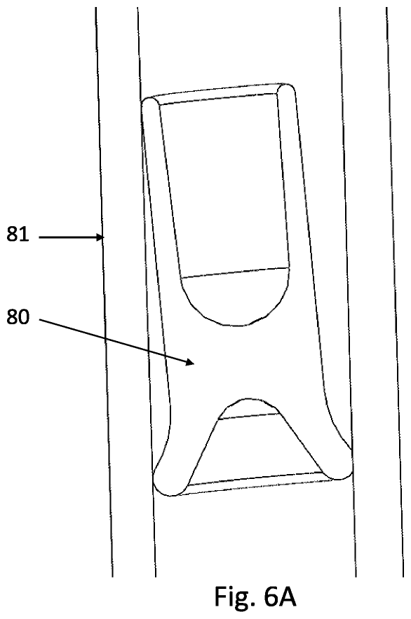

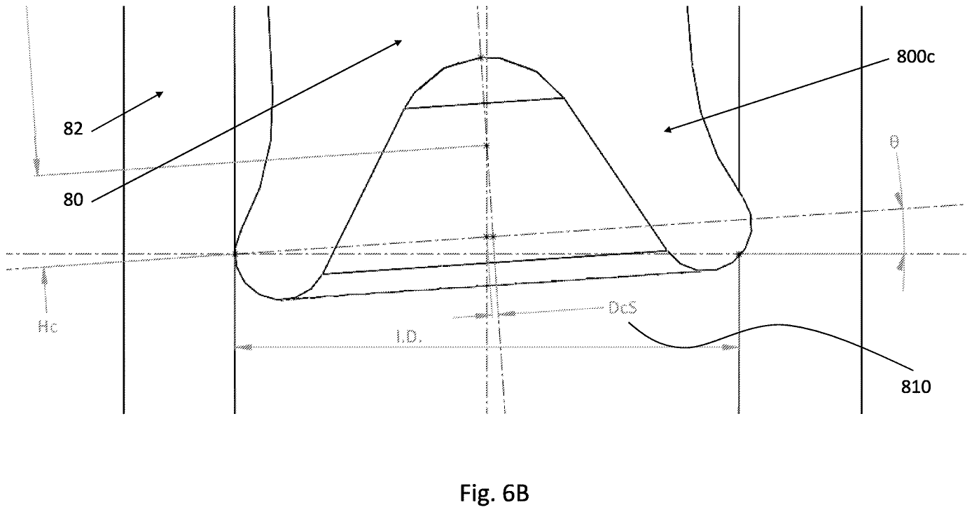

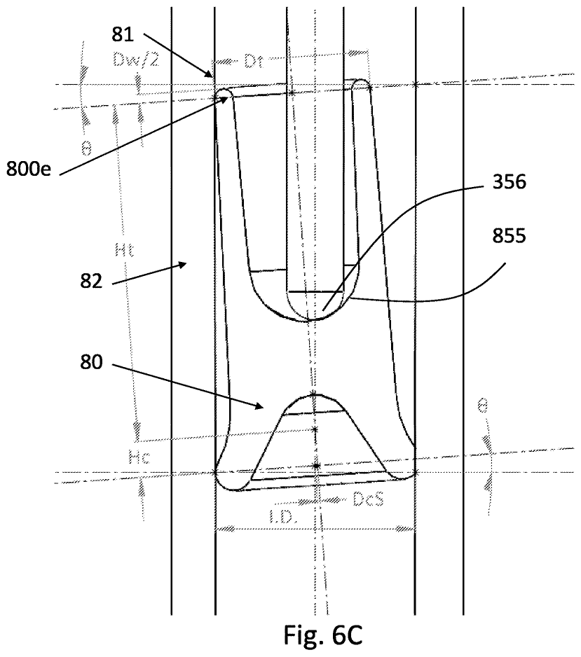

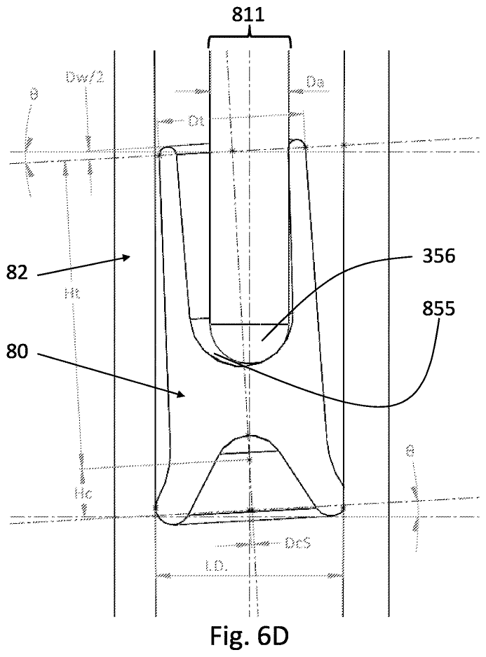

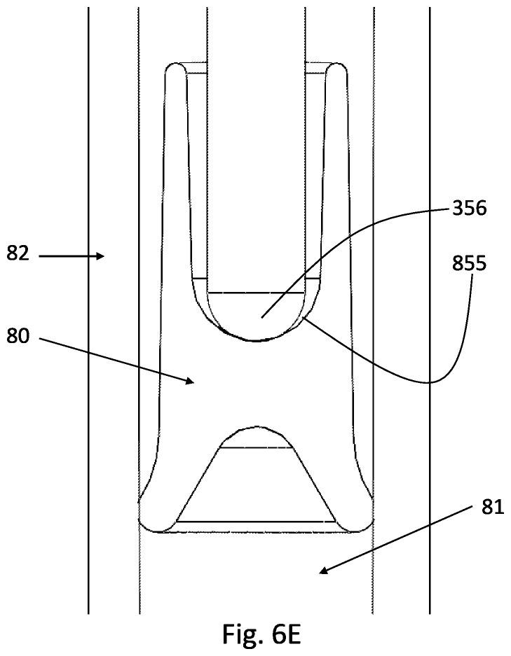

When selecting bung shape, system features and criteria such as drafted channel diameter (e.g., the channel's maximum diameter, and/or the channel's minimum diameter), the unlinked force actuator diameter, as well as a desired minimum and/or maximum squeeze percentage, can be used as inputs that constrain the shape of the bung. For example, a key design constraint for certain embodiments of a bung as described herein, used in a non-uniform diameter channel, and acted upon with an unlinked external force actuator, is the maximum allowable angular misalignment of the bung with respect to its concentricity with the channel. The maximum angular misalignment that is possible in a channel occurs at the largest channel diameter, when the bung angles away from the channel's center to the greatest degree possible (see FIG. 6A). For the bung to maintain a seal in a non-uniform diameter (e.g., drafted) channel, the bung's dimensions, shape, and other features are selected such that angular misalignment of the bung as it travels through the channel, including through the channel's largest diameter, does not break the bung's seal with the channel wall. The maximum allowable angular misalignment is the maximum angular misalignment that can occur at the largest channel diameter while maintaining a seal, by ensuring that the effective oval of the channel experienced by a tilted bung still involves contact of the bung sealing lip 800c (around its circumference) with the channel 81. This contact preferably involves at least 1% squeeze of the tip, and in some embodiments involves a minimum percent squeeze of 3-5%.

In addition, minimum squeeze percentage of the bung cup sealing diameter (see FIG. 5C) affects the range of a bung's angular misalignment inside a non-uniform channel. As shown in FIG. 6A, as the bung rotates away from concentricity with the channel, squeeze on one side of the bung's cup wall is reduced (e.g., to 0), and the bung is over-compressed on the opposite side of its cup-shaped cavity. For embodiments where the bung and the channel are concentric, minimum squeeze percentage can be defined using the following equation:

$$I . D . = {D}_{c} - {D}_{c} S \qquad ( 1 )$$

where I.D. is the largest diameter of the drafted channel, D_{c} is the cup sealing diameter 802, S is minimum squeeze percentage, and D_{c}S is squeeze amount 810 as shown in FIG. 6B.

As shown in FIG. 6B, the maximum allowable angular misalignment θ, which is the maximum angular misalignment that can occur while still maintaining a seal (e.g., when a bung, at the location corresponding to its cup sealing diameter 802, is in contact with a channel wall at a location within the channel corresponding to the channel's greatest diameter, with a nonzero squeeze percentage), can be determined from the following equation:

$$I . D . = ( {D}_{c} - {D}_{c} S ) cos ( θ ) \qquad ( 2 )$$

In some embodiments of a bung as described herein, equations 1-2 define the bung cup sealing diameter 802.

In some embodiments, the bung tail end diameter 808 should be as large as possible, but be smaller than the smallest channel diameter while allowing for a draft angle on the bung such that the bung can be molded.

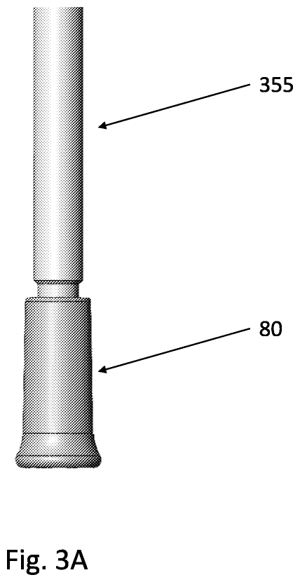

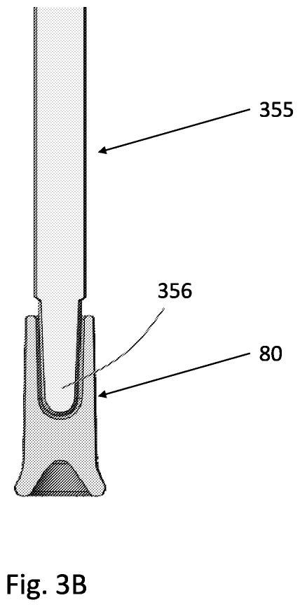

FIG. 6C shows a bung tilted in a channel where the end of the tail end of the bung (at 800e in FIG. 6C) makes contact with the inside of channel 81. The total length of a bung (see 80b in FIG. 1D) can be defined as the sum of Hₜ and H_{c}, as shown in FIG. 6C. FIG. 6D shows a bung tilted in a channel by the maximum tilt amount, while the stinger end 356 is engaged with the bung cavity 855. The stinger end region in FIG. 6D, which would correspond to stinger end region 356 in FIG. 3B for example, has a diameter Da (labelled as 811) that is larger than the diameter of the stinger shown in FIG. 6C; with a larger stinger diameter, the end of the tail end of the bung contacts the stinger before the end can contact the channel inside, which helps to reduce drag on the bung, which in turn reduces the chances of tilting.

In certain embodiments, total bung length 80b is 3 to 5 times greater than the channel's largest diameter; a bung length that is 3-5 times greater than the channel's largest diameter will help ensure that loss of sealing due to tilting does not occur.

In addition, in certain embodiments, the total bung length 80b is at least about 1.6 times the cup sealing diameter 802 (which may also be referred to as the bung diameter at the sealing lip). In further embodiments, the total bung length 80b is 2 to 3 times the cup sealing diameter 802; such ratios of total bung length 80b to cup sealing diameter 802 may further increase stability of the bung.

In certain embodiments, the ratio of total bung length (80b in the embodiment depicted in FIG. 1D) to tail-end force actuator mating cavity depth 807 (which may also be called tail-end stinger cavity depth) is about 1.6.

In some embodiments (see, e.g., FIG. 1D), a bung's critical dimensions may also include, for example, bung cup wall thickness 801, bung thickness 803 (also known as the distance between the cup cavity 800a and the bung tail-end stinger cavity 800b), sealing end length 804 (which includes the longest length of the cup cavity plus the sealing lip), and bung cup wall compliance support diameter 805. In addition, in embodiments of a bung where such features are not critical for the bung to travel effectively in a non-uniform diameter channel, such features may contribute to and improve the shape and function of the bung (e.g., bung concentricity with a non-uniform channel, bung cup sealing diameter compliance, and/or alignment of the bung to an unlinked external force actuator).

In certain embodiments, a bung's cup wall thickness (801 in FIG. 1D) is important for bung performance, and specifically to how well the bung, at the bung's cup sealing diameter (802 in FIG. 1D), maintains a seal with the channel wall at a drafted channel's minimum and maximum diameters. The bung cup wall is the primary support for the bung's seal within the non-uniform channel. In addition, in some embodiments, bung cup wall properties, including, for example, thickness, angle, length, compliance, etc., may influence the cup-shaped cavity shape (e.g., whether the cavity is a U-shaped cup, a wide V-shaped cup, a thin V-shaped cup, etc.). Bung embodiments with different applications may require different cavity sizes and/or shapes, and/or different cup wall properties (e.g., to obtain a desired force of the seal, and/or to allow for different degrees of bung deformation during travel in different channel diameter ranges).

In the embodiment depicted in FIG. 1D, the thickness of the bung between its seal-end cup-shaped cavity and its tail-end stinger cavity is shown as 803. In some embodiments, for example where an actuator rod is used to push the bung down the length of a drafted channel, the material between the bung's two cavities provides structure to the bung, which may be under pressure from its seal side and under force from the actuator. For example, the material between the bung's two cavities may help prevent a stinger rod breakthrough during operation (e.g., movement, compression, pressurization, etc.). Additionally, in certain embodiments, a relationship may exist between the bung's thickness 803 and the bung's cup wall thickness 801, where a ratio of these two thicknesses 803/801 that is from 1.5:1 to 5:1 helps ensure that the stinger does not push through the bung when force is applied to move the bung in the channel, while also helping to ensure the lip is deformed to achieve squeeze for sealing.

In further embodiments, the thickness of the bung between its seal-side and tail-side cavities (see, e.g., 803 in FIG. 1D) establishes the distance between an actuator's application of force, and the bung's center of friction. The force of friction of the bung is located along the bung cup seal diameter's plane, at the point of contact between the bung and channel. Changing the distance between the unlinked actuator (e.g., stinger rod) application of force and the bung's center of friction (by reducing or increasing internal bung thickness 803) affects angular misalignment forces. Larger distances between the force applied to the bung and the bung's center of friction increase rotational moments on the bung, if the force applied is not properly centered (e.g., because an unlinked actuator rod is misaligned), and thereby increase the potential for angular misalignment. An inverse relationship exists between the structural bung support due to a bung's internal thickness 803, and the potential for angular misalignment due to distance between an actuator's application of force and the bung's center of friction. As bung internal thickness increases, so too does the length from the center of friction (contact between the seal lip and channel wall) to the application of force from the actuator, which, in turn, increases the likelihood of angular misalignment (tilt). Accordingly, in certain embodiments, internal bung thickness (803) is important to bung design. In addition, the need for a thicker 803 is countered by an overall longer bung design.

In addition, in certain embodiments such as in the embodiment depicted in FIG. 4, there is a relationship between the radius of the bung's tail end cavity seat (see 855 in FIG. 1C, FIG. 4, FIGS. 5A and 5B) and the radius of an actuator's rounded end (see 356 in FIG. 4); for example, the radius of the bung's tail end cavity seat may be a certain amount larger than the radius of the actuator's rounded end. As shown in the embodiment depicted in FIG. 4, stinger 355 has a rounded end 356 (which may be called a stinger rod, piston, etc.) that presses into the bung tail end cavity 800b until the rounded end 356 of the stinger contacts the bung's spherical seat 855 and can begin pushing on the bung's spherical seat 855. The rounded end 356 engaging the bung's spherical seat 855 acts as a spherical joint. In certain embodiments, the radius of the stinger's rounded end 356 is at least 10% smaller, and in further embodiments is 20% smaller, than the radius of the bung's spherical seat 855. In some embodiments, the radius of the stinger's rounded end 356 is sufficiently smaller than the radius of the radius of the bung's spherical seat 855 to ensure the bung does not squeeze down and stick on the stinger's rounded end.

The bung cup wall compliance support diameter (see 805 in FIG. 1D) is the diameter of the circle formed by the outer contour of the bung cup wall. This dimension contributes to forming the sealing lip 800c and contributes to the mechanical strength of the cup wall.

In some embodiments, such as in the embodiment depicted in FIG. 1C, the bung's tail-end actuating rod cavity (800b) and the bung's tailing alignment walls (800d) can be designed, within the critical design constraints of features 80b and 808 (see FIG. 1D), to contribute to mitigating angular misalignment of the bung as the bung travels through a non-uniform diameter channel. For example, wall thickness and compliance can be designed to resist angular misalignment during bung travel in a drafted channel. In certain embodiments, the tail-end cavity can also contribute to reducing misalignment, via features intended to mate and align with the unlinked actuating rod, and/or features that reduce the distance between actuator force application and the bung center of friction.

In some embodiments, manufacturing processes such as injection molding may influence the design of the bung's actuator (e.g., stinger rod) alignment feature(s), including, without limitation, the dimensions (e.g., length, thickness) of the bung's tailing alignment walls. In addition, when using a manufacturing process such as injection molding, relative thickness values may be selected to ensure good solidification of the polymer in the mold without undesirable variations in the dimensions. Further, 1° to 3° drafts may be present in the bung's walls, on the interior walls of the tail-end stinger cavity and/or on the exterior bung wall sides. Such drafts may reduce frictional shear forces during manufacturing. Such drafts also may create self-aligning walls (for example, such drafts on the interior walls may promote proper alignment when the actuating rod exerts force on the bung).

In certain embodiments, bung dimensions are selected such that a minimum amount of clearance is maintained between the central bung structure (including the tail-end of the bung and the bung structure comprising the internal bung thickness 803, in the embodiment depicted in FIG. 1D) and the channel wall, including at the channel's minimum diameter. It was experimentally discovered that, for certain embodiments, no contact should be allowed between the bung and channel wall at the channel's minimum diameter, other than the contact between the channel wall and the part of the bung's cup wall that forms the seal at the cup sealing diameter (such part of the bung's cup wall is sealing lip 800c in FIG. 1C). Such clearance between the central bung structure and the channel wall at the channel's minimum diameter may serve to strengthen the bung cup seal with the channel wall and prevent jamming of the bung at smaller channel diameters. For some embodiments, ideal allowable clearance of the central bung structure is achieved when the central bung structure has a diameter that is not larger than 95% of the minimum diameter of the drafted channel.

The mechanical material properties of a bung also must be considered for fit and function of the bung mechanism. A bung material's shore hardness, specifically the compressibility of the material, will affect the performance of a bung as it travels in a channel having a non-uniform diameter across its length. In addition, in some embodiments, the coefficient of friction between the bung and wall of a drafted channel affects bung performance and directly affects certain use parameters, such as the force required from an unlinked force actuator to push the bung, and the amount of resistance that can be tolerated before the bung tears. It will be appreciated that in certain embodiments, if the coefficient of friction between the bung and drafted channel is too low, the bung will not remain in place when the force actuator is retracted, and if the coefficient of friction is too high, too much force will be needed to push the bung through the channel, and such force may overload the mechanism, draw too much power, and/or cause the force actuator to tear through the bung.

A bung as described herein may be used, for example, to seal off a single fluid (e.g., gas, liquid) or a series of fluids in a drafted channel. A bung as described herein can be particularly useful in exerting force over a given area within a channel that contains a first fluid such as air, to contain and/or move a second fluid in the channel that is or could be contaminated (e.g., blood). An example use of a bung as described herein is for a sealed, disposable cartridge, such as those cartridges commonly used in medical diagnostics.

It will be appreciated that the embodiments described above are set forth by way of example, and that the embodiments do not limit the scope of the invention. For example, in the embodiments described above, the elements generally are axis symmetric (bodies of revolution); however, the invention may also be used for non-round channels, such as oval or polygonal channels, as may be required in particular system geometries. Thus, while this invention has been particularly shown and described with references to certain embodiments thereof, it will be understood in light of the present disclosure by those skilled in the art that various changes in form and details may be made therein without departing from the scope of the invention, for example as encompassed by the appended claims.

What is claimed is:

1. A bung comprising a sealing end and an actuator end,
wherein the sealing end comprises a flexible concave cavity and a sealing lip, wherein the sealing end has a sealing end length that is the length of the flexible concave cavity and the sealing lip together,
wherein the actuator end comprises a stinger cavity, and
wherein the distance between the flexible concave cavity and the stinger cavity is the internal bung thickness, and wherein the internal bung thickness is from 1.5 to 5 times the sealing end length.

2. The bung according to claim 1 for use in a channel, wherein the distance between (i) the point of contact of the bung to a channel wall at the sealing lip, and (ii) the point of contact of the bung to a channel wall at the open end of the stinger cavity when the bung is tilted in the channel, is the total bung length, and wherein the total bung length is at least 1.6 times the diameter of the bung at the sealing lip.

3. The bung according to claim 1 for use in a channel, wherein the distance between (i) the point of contact of the bung to a channel wall at the sealing lip, and (ii) the point of contact of the bung to a channel wall at the open end of the stinger cavity when the bung is tilted in the channel, is the total bung length, and wherein the total bung length is at least about twice the diameter of the bung at the sealing lip.

4. The bung according to claim 2, wherein the total bung length is from two to three times the diameter of the bung at the sealing lip.

5. The bung according to claim 1 for use in a channel, wherein the distance between (i) the point of contact of the bung to a channel wall at the sealing lip, and (ii) the point of contact of the bung to a channel wall at the open end of the stinger cavity when the bung is tilted in the channel, is the total bung length, and wherein the ratio of the total bung length to internal bung thickness is at least 1.6.

6. The bung according to any one of claims 2-4, wherein the ratio of the total bung length to internal bung thickness is at least 1.6.

7. The bung according to claim 1 for use in a channel, wherein the distance between (i) the point of contact of the bung to a channel wall at the sealing lip, and (ii) the point of contact of the bung to a channel wall at the open end of the stinger cavity when the bung is tilted in the channel, is the total bung length, and wherein the total bung length is at least three times greater than the largest diameter of the channel.

8. The bung according to any one of claims 2-6, wherein the total bung length is at least three times greater than the largest diameter of the channel.

9. The bung according to claim 1 for use in a channel, wherein the distance between (i) the point of contact of the bung to a channel wall at the sealing lip, and (ii) the point of contact of the bung to a channel wall at the open end of the stinger cavity when the bung is tilted in the channel, is the total bung length, and wherein the total bung length is from three to five times greater than the largest diameter of the channel.

10. The bung according to any one of claims 2-6, wherein the total bung length is from three to five times greater than the largest diameter of the channel.

11. The bung according to any one of claims 5, 7, and 9, wherein the total bung length is at least 1.6 times the bung diameter at the sealing lip.

12. The bung according to claim 11, wherein the total bung length is from two to three times the bung diameter at the sealing lip.

13. The bung according to claim 1 for use in a channel, wherein the central bung structure, which is the portion of the bung comprising the stinger cavity and the distance corresponding to the internal bung thickness, does not have a diameter that is larger than 95% of the minimum diameter of the channel.

14. The bung according to any one of claims 2-12, wherein the central bung structure, which is the portion of the bung comprising the stinger cavity and the distance corresponding to the internal bung thickness, does not have a diameter that is larger than 95% of the minimum diameter of the channel.

15. The bung according to claim 1 for use in a channel, wherein the percent squeeze of the bung diameter at the sealing lip, when the bung travels through the channel, is no greater than 25% and no less than 3%.

16. The bung according to any one of claims 2-14, wherein the percent squeeze of the bung diameter at the sealing lip, when the bung travels through the channel, is no greater than 25% and no less than 3%.

17. The bung according to claim 1, wherein the bung, when traveling through a channel having a non-uniform diameter, maintains a seal with the wall of the channel.

18. The bung according to any one of claims 2-16, wherein the channel has a non-uniform diameter and wherein the bung, when traveling through the channel, maintains a seal with the wall of the channel.

19. The bung according to any one of claims 1-18 and a stinger, wherein the stinger cavity comprises a spherical seat, and wherein the stinger comprises a rounded end having a radius that is at least 10% smaller than the radius of the spherical seat.

20. The bung according to claim 19, wherein the radius of the rounded end is about 20% smaller than the radius of the spherical seat.

21. The bung according to any one of claims 1-20, wherein the wall forming the flexible concave cavity has a cup wall thickness, and wherein the ratio of the internal bung thickness to the cup wall thickness is from 1.5 to 5.

22. A kit comprising: the bung according to claim 1, and a microfluidic device comprising a drafted channel.

23. The kit according to claim 22, wherein the distance between (i) the point of contact of the sealing lip to a wall of the drafted channel, and (ii) the point of contact of the bung to a wall of the drafted channel at the open end of the stinger cavity when the bung is tilted in the drafted channel, is the total bung length, and wherein the total bung length is at least three times greater than the largest diameter of the drafted channel.

24. The kit according to claim 23, wherein the total bung length is from three to five times greater than the largest diameter of the drafted channel.

25. The kit according to any one of claims 23-24, wherein the ratio of the total bung length to internal bung thickness is at least 1.6.

26. The kit according to any one of claims 23-25, wherein the total bung length is at least about twice the bung diameter at the sealing lip.

27. The kit according to any one of claims 23-25, wherein the total bung length is from two to three times the bung diameter at the sealing lip.

28. The kit according to any one of claims 22-27, wherein the central bung structure, which is the portion of the bung comprising the stinger cavity and the distance corresponding to the internal bung thickness, has a diameter that is not larger than 95% of the minimum diameter of the drafted channel.

29. The kit according to any one of claims 22-28, wherein the percent squeeze of the bung diameter at the sealing lip, when the bung travels through the drafted channel, is no greater than 25% and no less than 3%.

30. The kit according to any one of claims 22-29, further comprising a stinger, wherein the stinger comprises a rounded end, wherein the stinger cavity comprises a spherical seat, and wherein the rounded end has a radius that is at least 10% smaller than the radius of the spherical seat.

31. The kit according to claim 30, wherein the rounded end has a radius that is about 20% smaller than the radius of the spherical seat.

32. The kit according to any one of claims 22-31, wherein the wall forming the flexible concave cavity has a cup wall thickness, and wherein the ratio of the internal bung thickness to the cup wall thickness is from 1.5 to 5.
